(19) United States
(12) Patent Application Publication
(10) Pub. No.: US 2020/0316757 A1
(43) Pub. Date: Oct. 8, 2020

(54) Switchable Ratchet Wrench

(71) Applicant: Shaodong Zhang, Zhangjiagang City (CN)

(72) Inventor: Shaodong Zhang, Zhangjiagang City (CN)

(21) Appl. No.: 16/595,474

(22) Filed: Oct. 8, 2019

(30) Foreign Application Priority Data
Apr. 4, 2019 (CN) 201920451044.4

(51) Int. Cl. B25B 13/46

(52) U.S. Cl. CPC B25B 13/463

(57) ABSTRACT

A switchable ratchet wrench includes a wrench body having a main hole for a ratchet wheel to be coupled and retained therein and a step hole for a switching unit to be mounted therein, wherein a diameter of a top portion of the step hole is smaller than a diameter of a lower portion of the step hole. A surrounding shoulder member is arranged on the top of the lower portion of the step hole. A retaining slot is provided and bridge between the main hole and the lower portion of the step hole. The ratchet wheel has a plurality of external teeth and a driving portion. A braking member which has a plurality of engaging teeth and a switching portion. A holder member is pushed by a spring to push and lean against the switching portion, so as to act on the braking member when the switching button is rotate, which allows the engaging teeth of the braking member to switch the rotation direction of the ratchet wheel between a clockwise direction and a counterclockwise direction.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention particularly relates to the field of direction switching technology for ratchet wrench.

### Description of Related Arts

According to the FIG. 7 of the Taiwan Pat. No. 106144171 (Certificate No. 1652147), entitled Switching Device and Ratchet Wrench Having the Switching Device, a latest direction switching technology is illustrated, wherein a longitudinal hole is provided in a wrench body and a longitudinal shaft is formed on a switching unit to couple with the longitudinal hole. Then, it utilizes a retaining ring to limit the longitudinal shaft from axially escaping from the longitudinal hole. The top end of the longitudinal shaft has a cam shaped switching button connected thereon. The switching button is positioned on the top surface of the wrench body, so as to allow the switching button to increase torque for rotating the longitudinal shaft for a certain angle to control the rotation direction of ratchet wheel in clockwise or counterclockwise. Unfortunately, this prior technology has the following drawbacks.

First, usually, the longitudinal shaft and the switching button are integrally made as a single piece. Due to significant differences of their exterior shapes, it is mainly made by casting first and then shaped by cutting that the overall manufacturing cost is difficult to be further reduce and it is less conducive to mass production.

Second, the longitudinal shaft is coupled with the longitudinal hole of the wrench body through a retaining ring. Since such arrangement is limited to the assembling tolerance of the retaining ring, when the switching button links the longitudinal shaft, the longitudinal shaft more or less has a remaining gap that allows unwanted up and down movement, so that the smoothness of the operation of the device is inevitably affected.

Hence, in view of the above drawbacks of the conventional technology, the present invention is developed to solve the above-mentioned issues of the prior art.

### SUMMARY OF THE PRESENT INVENTION

The present invention provides a switchable ratchet wrench, which has a step hole provided in a wrench body for a switching unit to be mounted therein. A diameter of a top portion of the step hole is smaller than a diameter of a lower portion of the step hole, so that a top end of the lower portion is coupled with a surrounding shoulder member. The switching unit has a shaft member coupled with the step hole. The shaft member correspondingly has a small shaft and a large shaft. The large shaft has a transverse hole provided therein. The small shaft comprises a switching button provided and assembled on a top surface of the surrounding shoulder member to retain the shaft member from escaping from the step hole. There is a prepressing element provided and mounted between the surrounding shoulder member and the large shaft, so as to provide a downward prepressure to the shaft member and the switching button. A spring and a holder member are mounted in the transverse hole. The spring is arranged to push an external end of the holder member to lean against the switching portion, so as to act on a braking member when the switching button is rotate, which allows the engaging teeth of the braking member to switch the rotation direction of the ratchet wheel between a clockwise direction and a counterclockwise direction.

Accordingly, the present invention allows the shaft member and the switching button to be manufactured independently, such that the troublesome due to casting can thus be avoided, while the assembling of the shaft member and the switching button is relatively simple and easy and the overall manufacturing cost of the prevent invention better meets the economic and efficient requirement.

Besides, the present invention provides a constant downward positioning ability for the shaft member and the switching button by means of the prepressing member, such that when the switching button links the shaft member to rotate, any remaining gap can be neglected and ignored, so as to provide a precise and smooth operation for the present invention.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded view of a preferred embodiment of the present invention.

FIG. 2 is a perspective view of the above preferred embodiment of the present invention.

FIG. 3 is a longitudinal sectional view of FIG. 2.

FIG. 4 is a lateral sectional view of FIG. 2.

FIG. 5 is a sectional view of the above preferred embodiment of the present invention illustrating the ratchet wheel switched to relatively clockwise rotatable.

FIG. 6 is a sectional view of the above preferred embodiment of the present invention, illustrating the ratchet wheel switched to relatively counterclockwise rotatable.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

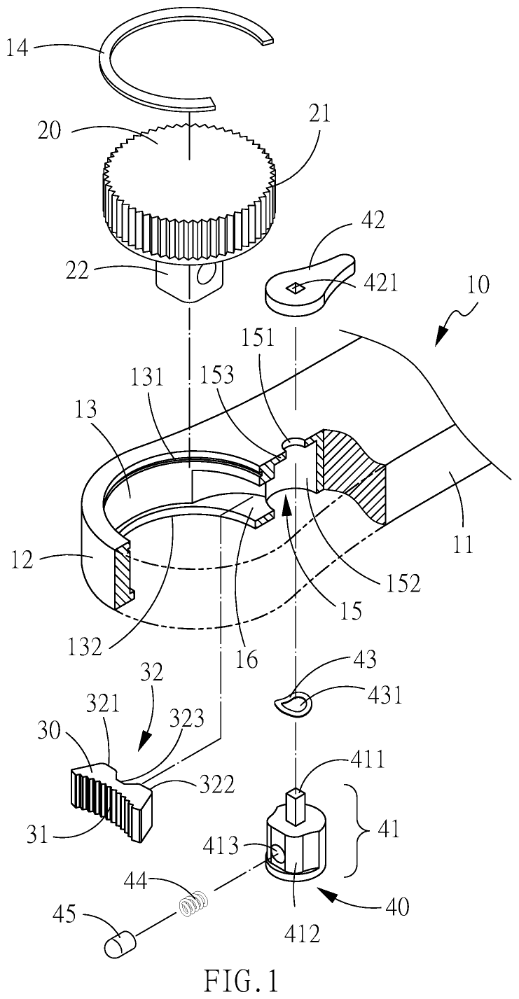

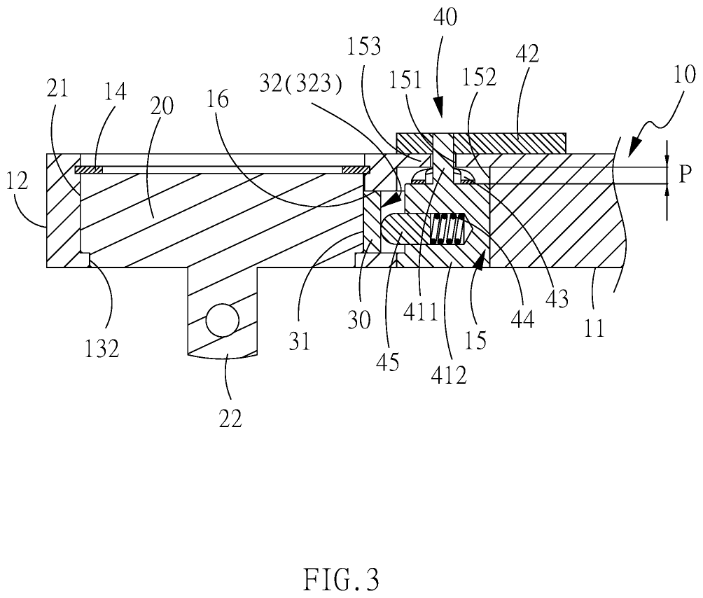

Referring to FIGS. 1-6, a switchable ratchet wrench according to preferred embodiment of the present invention is illustrated, which comprises a wrench body 10, a ratchet wheel 20, a braking piece 30, and a switching unit 40.

The wrench body 10 comprises an enlarged circular head body 12 integrally connected with an end of a wrench rod 11. The head body 12 has a main hole 13 penetrating the head body 12 from a top to a bottom thereof. The main hole 13 has a circular engaging groove 131 provided in a top portion thereof for mounting a retaining ring 14. The main hole 13 also has an inner flange 132, having a reduced diameter, circularly and inwardly extended at a bottom portion thereof. The wrench rod 11 further has a step hole 15 formed at a position adjacent to the main hole 13 and penetrated from a top to a bottom of the wrench rod 11 such that the main hole 13 and the step hole 15 are extending parallel to each other. The diameter of a top portion 151 of the step hole 15 is smaller than the diameter of a lower portion 152 of the step hole 15, such that a surrounding shoulder member 153 is formed around a top end of the lower portion 152 of the step hole 15, wherein an arc shape retaining slot 16 is indented in a surrounding wall of the head body 12 and positioned bridging between the main hole 13 and the lower portion 152 of the step hole 15.

The ratchet wheel 20 is retained and coupled in the main hole 13, wherein a periphery edge of a top surface of the ratchet wheel 20 is retained by the retaining ring 14 and a periphery edge of a bottom surface of the ratchet wheel 20 is retained by the inner flange 132 of the main hole 13 of the head body 12. The ratchet wheel 20 has a plurality of external teeth 21 formed around an outer circumferential surface thereof and comprises a driving portion 22 coaxially and downwardly extended out of the main hole 13 from the bottom surface thereof to form a square shaped connector adapted for matching and coupling with a corresponding socket member (not shown). Besides, the driving portion 22 may also be embodied as a hexagonal or polygonal socket hole adapted for directly engaging with a bolt or a nut.

The braking member 30 is arranged in the retaining slot 16 in such a manner that the braking member 30 is able to be switched between a first portion and a second portion of an indented curved wall of the retaining slot 16. An outer side of the braking member 30 has a plurality of engaging teeth 31 adapted to be engaged with the external teeth 21 of the ratchet wheel 20. An inner side of the braking member 30 provides a switching portion 32 which comprises a first blocking edge 321, a second blocking edge 322, and a groove 323 formed between the first blocking edge 321 and the second blocking edge 322.

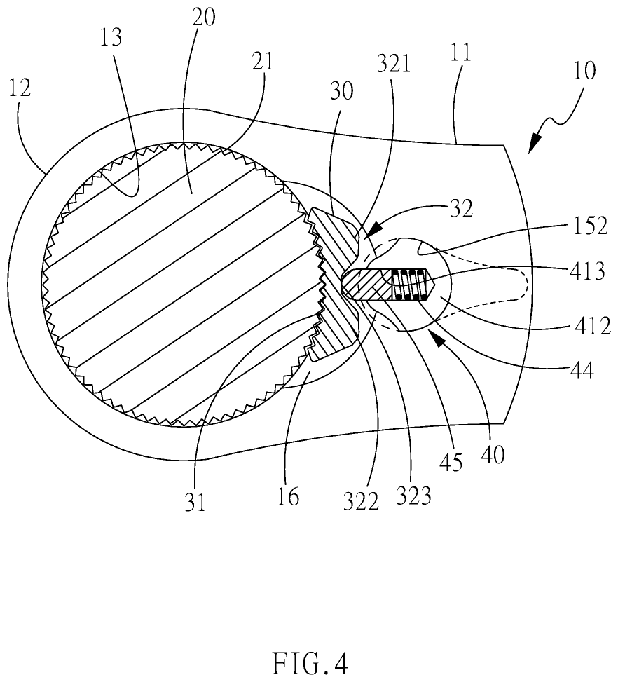

The switching unit 40 comprises a shaft member 41, a switching button 42, a prepressing element 43, a spring 44, and a holder element 45. The shaft member 41 is received and coupled in the step hole 15 and comprises a small shaft 411 matching the top portion 151 and a large shaft 412 matching the lower portion 152 of the step hole 15. The large shaft 412 has a transverse hole 413 radially formed therein, such that one end of the transverse hole 413 is extended to communicate with the retaining slot 16, while the other end of the transverse hole is a closed end. The small shaft 411 has a non-circular shape and a top end extended to protruded out of a top surface of the surrounding shoulder member 153. The switching button 42 has a fastening hole 421 provided for a top portion of the small shaft 411 to be inserted therein and riveted together so as to connect and fasten the switching button 42 and the small shaft 411 to form an integral piece. Accordingly, the large shaft 412 is retained below the bottom surface of the shoulder member 153 and the switching button 42 is retained above the top surface of the shoulder member 153, preventing the shaft member 41 from escaping from the step hole 15. In addition, a spacing P is formed between the bottom surface of the shoulder member 153 and the top end of the large shaft 412 for mounting the prepressing element 43 therein, such that the prepressing element 43 can provide a downward prepressure against the shaft member 41 and the switching button 43. Therefore, the bottom surface of the switching button 43 has a constant tendency to push and lean against the top surface of the shoulder member 153. The prepressing element 43 can be embodied as a waveform washer, which comprises a central hole 431 for the small shaft 411 to pass through. The spring 44 is installed in the transverse hole 413 and the holder member 45 has an inner end slidably inserted in the transverse hole 413 such that the spring 44 applies a pressing force to the holder member 45 to ensure an outer end of the holder member 45 pressing against the braking member 30 to engage with the ratchet wheel 20. Referring to FIG. 4, when the switching button 42 is rotated to be held in a center position, the spring 44 applies a resilient force to the holder member 45 to ensure the outer end of the holder member 45 pressing in the groove 323 of the switching portion 32 of the braking member 30, ensuring the engaging teeth 31 of the braking member 30 fully engaged with the external teeth 21 of the ratchet wheel 20 that blocks and secures the ratchet wheel 20 from rotating about the main hole 13.

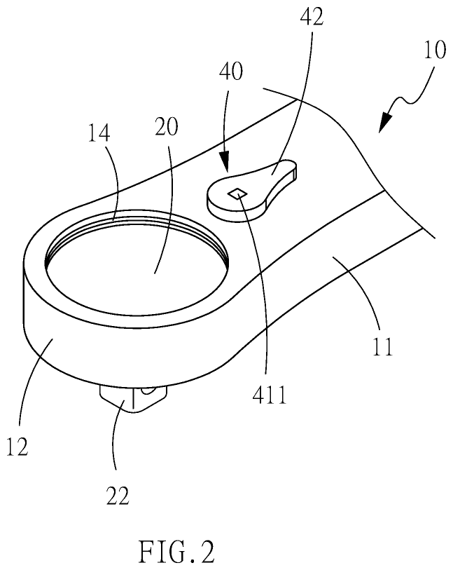

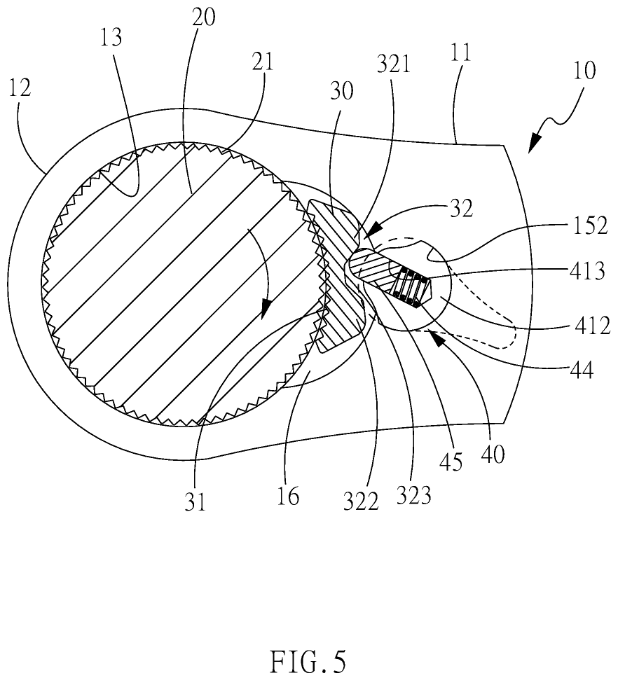

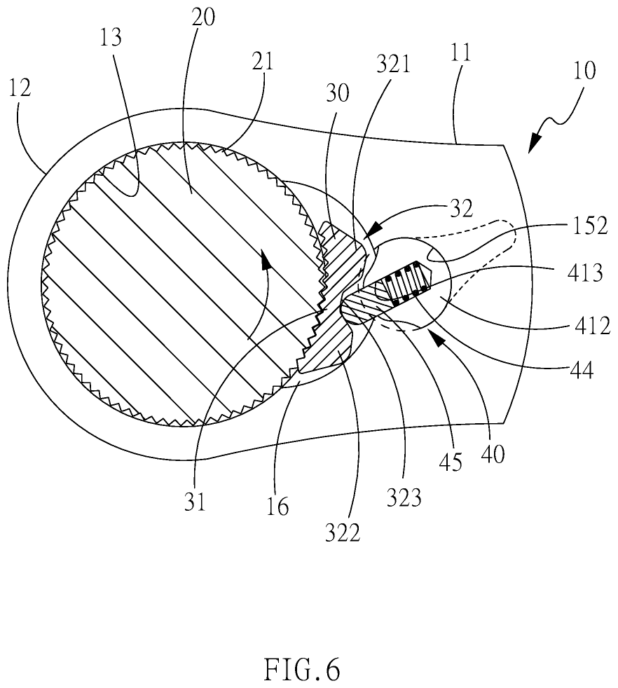

Referring to FIGS. 2 and 5, when the switching button 42 is rotated clockwise to drive the holder member 45 pressing on the first blocking edge 321 of the switching portion 32, the braking member 30 is held between the external teeth 21 of the ratchet wheel 20 and the first portion of the curved wall of the retaining slot 16, such that the ratchet wheel 20 is only allowed to unidirectionally rotate clockwise about the main hole 13, so as to allow the wrench body 10 to exert back and forth and to unidirectionally rotate the ratchet wheel 20 for rapidly fastening a socket member, a bolt or a nut. As shown in FIG. 6, when the switching button 42 is rotated counterclockwise to drive the holder member 45 pressing on the second blocking edge 322 of the switching portion 32, the braking member 30 is held between the external teeth 21 of the ratchet wheel 20 and the second portion of the curved wall of the retaining slot 16, such that the ratchet wheel 20 is only allowed to unidirectionally rotate counterclockwise about the main hole 13, so as to allow the wrench body 10 to exert back and forth and to unidirectionally rotate the ratchet wheel 20 for rapidly unfastening a socket member, a bolt or a nut.

In view of the above description, the present invention has at least the following advantages.

First, the shaft member and the switching button of the present invention can be mass produced independently, which can overcome the drawbacks of the conventional manufacturing method by means of casting. Besides, the assembling of the shaft member and the switching button is simple, which can be implemented through riveting, screwing, or other means. Therefore, the overall manufacturing cost meets the economic and efficient requirements.

Second, the present invention utilizes the prepressing member to provide the switching button a constant downward holding tendency onto the wrench body, such that when the switching button drives the shaft member to rotate, the residual gap thereof can be neglected and ignored, so as to provide an ingenious and precision experience when operating the switching button.

In view of above, the structure and arrangement of the present invention is novel and advantageous, which is certainly an innovative design that meets the novelty and unobviousness requirement for a utility patent. However, what has been mentioned above is only one of the preferred embodiments of the present invention, which shall not be used to limit the scope of the practice of the present invention. In other words, all equivalent alternatives and modifications according to the claims of the present invention shall still be covered by the claimed scope of the present invention.

What is claimed is:

1. A switchable ratchet wrench, comprising:
a wrench body, having a main hole and a step hole therein, wherein a diameter of a top portion said step hole is smaller than a diameter of a lower portion of said step hole, wherein a surrounding shoulder member is formed around a top end of said lower portion of said step hole and a retaining slot is formed bridging between said main hole and said lower portion of said step hole;
a ratchet wheel, which is retained and coupled in said main hole of said wrench body, having a driving portion and a plurality of external teeth formed around an outer circumferential surface thereof;
a braking member, which is arranged in said retaining slot, having a plurality of engaging teeth formed on an outer side thereof and arranged to be engaged with said external teeth of said ratchet wheel and a switching portion provided on an inner side thereof; and
a switching unit, which comprises a switching button, a shaft member received and coupled in said step hole, wherein said shaft member comprises a small shaft matching said top portion of said step hole and a large shaft matching said lower portion of said step hole, wherein said large shaft has a transverse hole radially formed therein extended to communicate with said retaining slot, wherein said switching button is connected to said small shaft, such that said switching button is retained above a top surface of said surrounding shoulder member and said large shaft is retained below a bottom surface of said surrounding shoulder member that said shaft member is prevented from axially escaping from said step hole, wherein a prepressing element is provided and mounted between said surrounding shoulder member and said large shaft, so as to ensure said switching button leaning against said top surface of said surrounding shoulder member, wherein a spring is installed in said transverse hole and a holder member has at least an inner portion slidably inserted in said transverse hole such that said spring applies a pressing force to said holder member to ensure an outer end of said holder member pushing and leaning against said switching portion of said braking member, so that said braking member is able to be driven to rotate and allow said engaging teeth of said braking member to switch a rotation direction of said ratchet wheel between clockwise and counterclockwise.

2. The switchable ratchet wrench, as recited in claim 1, wherein a spacing is provided between said bottom surface of said surrounding shoulder member and a top end of said large shaft so as for mounting said prepressing element.

3. The switchable ratchet wrench, as recited in claim 2, wherein said prepressing element is a waveform washer having a center hole for said small shaft to pass through.

4. The switchable ratchet wrench, as recited in claim 1, wherein said main hole and said step hole both penetrate through said wrench body from a top to a bottom thereof in a parallel manner.

5. The switchable ratchet wrench, as recited in claim 2, wherein said main hole and said step hole both penetrate through said wrench body from a top to a bottom thereof in a parallel manner.

6. The switchable ratchet wrench, as recited in claim 3, wherein said main hole and said step hole both penetrate through said wrench body from a top to a bottom thereof in a parallel manner.

7. The switchable ratchet wrench, as recited in claim 1, wherein a periphery of said small shaft of said shaft member is non-circular and a top of said small shaft is protruded from said top surface of said surrounding shoulder member, wherein said switching button has a hole therein for a top end of said small shaft to insert therein.

8. The switchable ratchet wrench, as recited in claim 2, wherein a periphery of said small shaft of said shaft member is non-circular and a top of said small shaft is protruded from said top surface of said surrounding shoulder member, wherein said switching button has a hole therein for a top end of said small shaft to insert therein.

9. The switchable ratchet wrench, as recited in claim 3, wherein a periphery of said small shaft of said shaft member is non-circular and a top of said small shaft is protruded from said top surface of said surrounding shoulder member, wherein said switching button has a hole therein for a top end of said small shaft to insert therein.

10. The switchable ratchet wrench, as recited in claim 1, wherein said retaining slot has an indented curved wall and said braking member is allowed to switch between a first portion and a second portion of said curved wall of said retaining slot, wherein said switching portion of said braking member has a first blocking edge, a second blocking edge, and a groove formed between said first blocking edge and said second blocking edge.

11. The switchable ratchet wrench, as recited in claim 2, wherein said retaining slot has an indented curved wall and said braking member is allowed to switch between a first portion and a second portion of said curved wall of said retaining slot, wherein said switching portion of said braking member has a first blocking edge, a second blocking edge, and a groove formed between said first blocking edge and said second blocking edge.

12. The switchable ratchet wrench, as recited in claim 3, wherein said retaining slot has an indented curved wall and said braking member is allowed to switch between a first portion and a second portion of said curved wall of said retaining slot, wherein said switching portion of said braking member has a first blocking edge, a second blocking edge, and a groove formed between said first blocking edge and said second blocking edge.

13. The switchable ratchet wrench, as recited in claim 1, wherein said wrench body has a circular engaging groove provided in a top portion of said main hole for mounting a retaining ring and an inner flange, having a reduced diameter, circularly and inwardly extended at a bottom portion thereof, wherein a top surface of said ratchet wheel is retained by said retaining ring and a bottom surface of said ratchet wheel is retained by said inner flange of said main hole.

14. The switchable ratchet wrench, as recited in claim 2, wherein said wrench body has a circular engaging groove provided in a top portion of said main hole for mounting a retaining ring and an inner flange, having a reduced diameter, circularly and inwardly extended at a bottom portion thereof, wherein a top surface of said ratchet wheel is retained by said retaining ring and a bottom surface of said ratchet wheel is retained by said inner flange of said main hole.

15. The switchable ratchet wrench, as recited in claim 3, wherein said wrench body has a circular engaging groove provided in a top portion of said main hole for mounting a retaining ring and an inner flange, having a reduced diameter, circularly and inwardly extended at a bottom portion thereof, wherein a top surface of said ratchet wheel is retained by said retaining ring and a bottom surface of said ratchet wheel is retained by said inner flange of said main hole.

16. The switchable ratchet wrench, as recited in claim 1, wherein an end of said transverse hole is communicated with said retaining slot and another end of said transverse hole is closed end.

17. The switchable ratchet wrench, as recited in claim 2, wherein an end of said transverse hole is communicated with said retaining slot and another end of said transverse hole is closed end.

18. The switchable ratchet wrench, as recited in claim 3, wherein an end of said transverse hole is communicated with said retaining slot and another end of said transverse hole is closed end.
